(19) United States
(12) Patent Application Publication
(10) Pub. No.: US 2017/0301017 A1
(43) Pub. Date: Oct. 19, 2017

(54) METHOD AND SYSTEM FOR MULTIPLE FUNCTIONS IN THE PRIMARY CAPITAL MARKET

(71) Applicants: VUK MAGDELINIC, TORONTO (CA); SEUNGHAN RYOO, TORONTO (CA)

(72) Inventors: VUK MAGDELINIC, TORONTO (CA); SEUNGHAN RYOO, TORONTO (CA)

(21) Appl. No.: 15/488,721

(22) Filed: Apr. 17, 2017

Related U.S. Application Data
(60) Provisional application No. 62/323,673, filed on Apr. 16, 2016.

(51) Int. Cl. G06Q 40/04

(52) U.S. Cl. CPC G06Q 40/04

(57) ABSTRACT

An interactive digital platform for trading in primary market offerings of securities comprises a pre-deal activity module and a deal execution module. The pre-deal activity module is configured to allow a plurality of users to perform credit and market analysis, predictive analytics, communications functions, relationship management, and information management. The deal execution module configured to allow the plurality of users to perform a deal execution workflow, order management, best execution analysis, documentation management, and regulatory compliance.

### CROSS REFERENCE TO RELATED APPLICATIONS

This application claims the benefit of the filing date of U.S. provisional patent application Ser. No. 62/323,673, filed on Apr. 16, 2016, the disclosures of which are incorporated herein by reference.

### FIELD OF THE INVENTION

The present disclosure relates to the field of computer-assisted business methods, and to systems for implementing such methods. More specifically, the present disclosure relates to computer-based methods for supporting multiple functions such as communication, information management, deal execution, stakeholder collaboration, pricing calculation, securities offering and issuance, and analytics for issuers, investors, and dealers.

### BACKGROUND OF THE INVENTION

The primary market and the process of origination for securities has not changed for decades and is still a manual process that is paper heavy and includes phone calls and excel spreadsheets. The existing process lacks transparency, is time consuming, and impedes the efficient allocation of capital. Since the 2008 financial crisis, increasingly stringent regulation has adversely impacted dealer's market-making capabilities in bond markets. When coupled with increasing new issuances driven by the low interest rate environment, there has been a sharp decline in secondary market trading activities, which in turn has exacerbated primary market challenges including inefficient new issue pricing and price discovery. In addition, the manual nature of the existing process makes the primary market inaccessible to many investors including some institutional and many retail investors. This is undesirable for a well-functioning capital market. Furthermore, because of these structural problems, many corporate issuers have a limited ability to raise capital in the institutional capital markets as they need to meet high size and scale requirements to justify costs and operational inefficiencies involved in the process.

Additionally, issuers, investors, and dealers exchange many disparate pieces of information and market analysis all in different formats and are each then consumed by cumbersome manual reviews. Market information tends to be point-in-time and is not useful in a market that changes every day.

Transparency during the sales process is also lacking—this includes transparency in pricing, costs, allocations, and supply and demand in general. Additionally, issuers do not have tools to prepare for new issue offerings or to manage relationships with their dealers and investor base. Vitally, dealers, issuers and investors do not have tools to gauge market interest between one another regarding potential offerings. All market participants also have limited ability to track activities involved in securities offerings for the purpose of regulatory and internal management reporting.

Transaction logistics in the primary market are phone call and email based. Time and financial resources lost to sending and receiving documents, aggregating and processing market information, regulatory compliance, performing manual credit research searching electronic mailboxes, making phone calls, and trying to contain information leakage is staggering. In addition, financial analysis is not real-time and does not help market participants make data driven decisions.

Other aspects and features of the present invention will become apparent to those ordinarily skilled in the art upon review of the following description of specific embodiments of the invention in conjunction with the accompanying figures.

### BRIEF SUMMARY

It is an object of the present invention to mitigate limitations within the prior art relating to the field of computer-assisted business methods, and to systems for implementing such methods, and more specifically, to computer-based methods for supporting multiple functions such as communication, information management, deal execution, stakeholder collaboration, pricing calculation, securities offering and issuance, and analytics for issuers, investors, and dealers.

Embodiments of the invention include an interactive digital platform for trading in primary market offerings of securities comprises a pre-deal activity module and a deal execution module. The pre-deal activity module is configured to allow a plurality of users to perform credit and market analysis, predictive analytics, communications functions, relationship management, and information management. The deal execution module configured to allow the plurality of users to perform a deal execution workflow, order management, best execution analysis, documentation management, and regulatory compliance.

In some embodiments of the invention the credit and market analysis comprises publish pricing levels to other users of the plurality of users using a common format, swap analysis, evaluation of secondary market liquidity, machine comparison of covenant terms, and evaluation of profiles of the plurality of users.

In some embodiments of the invention the predictive analytics comprises machine learning and big data, evaluating participation in primary markets, the evaluation of current and historic secondary market trading levels of correlated securities, and the prediction of new issue levels.

In some embodiments of the invention the communications functions comprise publishing pricing indications publicly or privately to other users of the plurality of users.

In some embodiments of the invention the relationship management comprises the tracking of historical records of deal participation by the plurality of users.

In some embodiments of the invention the information management comprises receiving a plurality of digitized primary market data from a plurality of sources, the platform digitizing the plurality of digitized primary market data, converting the plurality of digitized primary market data into a common format, and storing the plurality of primary market data into a database;

In some embodiments of the invention the deal execution workflow comprises enabling the plurality of users to create a plurality of deals and populate the plurality of deals with a plurality of existing reverse inquiries, soft sounding being used to gauge interest in the plurality of deals.

In some embodiments of the invention the order management comprises enabling the plurality of users to populate and allocate orders and submit orders for trading.

In some embodiments of the invention the best execution analysis comprises the utilization, by the platform, of bid and offer data to produce a weighting of pricing trends.

In some embodiments of the invention the documentation management comprises the indexing of the plurality of digitized primary market data to enable the plurality of users to search the plurality of digitized primary market data.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 provides an overview of the system and its workflow that allows users to perform all primary market-related activities on a digital platform.

FIG. 2 provides an overview of digital tools that allows users to monitor and perform advanced analysis on pricing and market information.

FIG. 3 illustrates a suite of predictive analytics tools that provide users with unique market insights.

FIG. 4 illustrates a suite of communication tools that provide users with multiple, user-friendly, channels of communications.

FIG. 5 provides an overview of the suite of relationship management tools.

FIG. 6 provides an overview of systems to aggregate, process, and integrate data from multiple sources into and out of a centralized data aggregation and processing, in the context of primary capital markets.

FIG. 7 delivers an overview of customizable digital deal execution workflow with permission-controlled access provided to multiple stakeholders.

FIG. 8 outlines an overview of digital order book management and allocation systems.

FIG. 9 provides an overview of customizable digital deal execution workflow with permission-controlled access provided to multiple stakeholders.

FIG. 10 illustrates a suite of tools available for users to manage multiple financial documents.

FIG. 11 contains a suite of tools available for users to comply with the relevant regulatory compliance requirements.

FIG. 12 shows an overview of continuous supervised machine learning process using regression models for the purpose of Digital New Issue Indication predictive analytics tool.

FIG. 13 shows an overview of continuous supervised machine learning process using classification models for the purpose of Lead Dealer Prediction predictive analytics tool.

FIG. 14 illustrated a table of financial data and rates.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

The present invention is directed to the field of computer-assisted business methods, and to systems for implementing such methods, and more specifically, to computer-based methods for supporting multiple functions such as communication, information management, deal execution, stakeholder collaboration, pricing calculation, securities offering and issuance, and analytics for issuers, investors, and dealers.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Embodiments of the invention comprise a system that will digitize primary market data, including the processes, logistics, analytics, issuances, communication, collaboration, information management, relationship management, predictive analytics, cognitive computing and big data analytics, and any other functions. Users for this platform are issuers, dealers, investors, and/or any other primary market participants, and the platform digitizes their experience with deal-related and non-deal-related primary market activities.

The system brings all primary market participants, including issuers, dealers, investors, legal counsel, and rating agencies, among others, on to a digital platform. The system automates manual functions, increases market transparency, facilitates price discovery, allows users to execute primary market deals, and aggregates, processes and manages information, among others.

Embodiments of the invention comprise an electronic system built for the capital markets that allows users to perform a plurality of the following functions: manage information, documentation, relationships, and logistics; communicate directly with issuers, dealers, and/or investors, among others; submit inquiries and/or bids directly to an issuer; manage the deal lifecycle; distribute securities using conventional clearing and settlement methods; generate and fill an order book; allocate orders; leverage tools to distribute data between issuers, dealers, and investors, among others; conduct auctions for multiple securities from one or more issuers; utilize interactive calendaring functions, meeting management, marketing campaigns, roadshows, among other marketing and sales activities; access real-time market analytics and indices covering fixed income and/or equity markets; generate cognitive computing and big data analysis form the platform directly; use predictive analytics; and generate custom reports for any of the features or views based on the underlying subject matter.

The electronic system is designed for parties involved in the capital raising industry. The system comprises a secure cloud-based platform that employs both systemized and ongoing user verification and identification protocols. The system's cloud infrastructure ensures highest availability and performance with multiple availability zones and data centres globally. The system allows users to communicate and build relationships with other issuers, dealers and investors; send and receive financial information efficiently; manage all primary market-related information in one-place; and perform advanced and predictive analytics using private and public data. Through these capabilities, the system provides tools to assist issuers in all stages of capital raising and further comprises using data-driven methods to enhance investor and dealer relationship management, communicating with key stakeholders real-time on a secure system, discreetly discovering potential investor demand, and accessing the most up-to-date market intelligence directly from dealers, investors and other participants. Similarly, the system provides sophisticated tools to assist investors with all stages of investing in new issues of securities including building and measuring relationships with different market stakeholders, communicating with key stakeholders real-time on a secure system, enhancing decision-making with sophisticated credit analysis tools and intelligence, digitally discovery price and new issue supply through a discreet channel, and improving operational efficiency through the use of a centralized depository for all relevant documents.

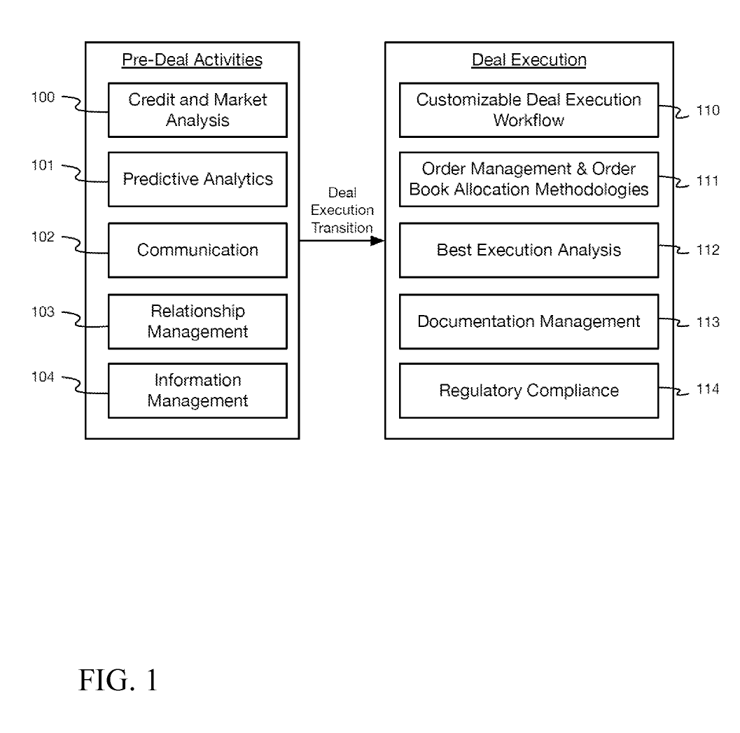

FIG. 1 illustrates an overview of the system designed to facilitate pre-deal data processing and multi-party communication, deal execution transition, and deal execution workflow. The workflow is highly customizable. Depending on deal type and asset class, the system's deal execution workflow is customizable in terms of execution stages, fields, and conditions. The system provides a seamless suite of modules that enable users to participate in the primary capital markets, in the context of both pre-deal data processing and communication or deal related market activities. The platform provides access to three core user groups; securities issuers, investors, and dealers and comprises an end-to-end primary market platform. Given the heavily regulated nature of the debt issuance industry, the system provides deal workflow depending on market segment and region, provides recordkeeping and an audit trail, and allows for strict information control.

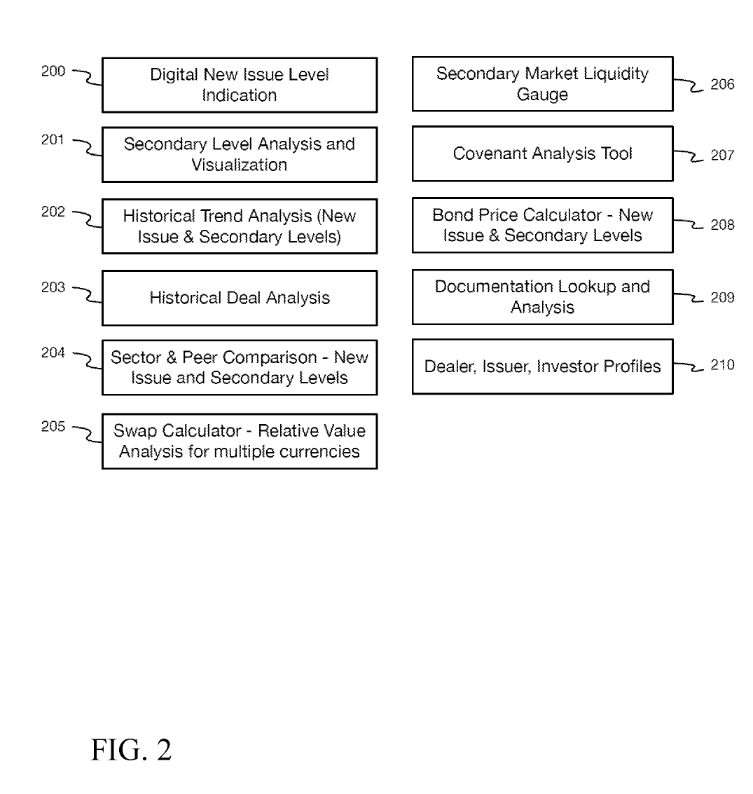

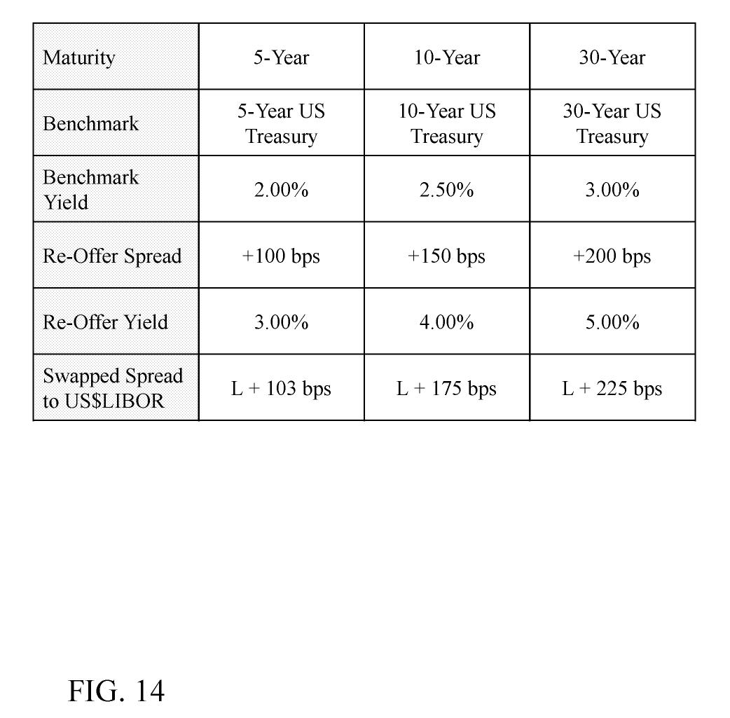

FIG. 2 illustrates a suite of digital tools that allow users to monitor and perform advanced analysis 100 on pricing, credit, and market data. Digital New Issue Level Indication module 200 provide users with an ability to publish indicative new issue pricing levels (“Pricing Indication”) to other market participants. Currently, issuers and investors receive these indications from multiple dealers on a weekly basis in disparate formats and channels. The purpose of such communication is to allows users to indicate their view of the pricing level of a new issue for a specific issuer given the prevailing market conditions. Through digitizing the process and converting data into structured forms, the system is able to generate intelligence by utilizing machine learning and big data technologies to provide advanced predictive analytics and data-driven insights. FIG. 14 illustrates an example of a Pricing Indication sheet sent by a dealer to an issuer.

The Digital New Issue Indication 200 tool allows dealers to manage and communicate these indications in one place through the system. Through the use of the system, dealers are able to publish pricing indications publicly or privately with specified target user groups. Moreover, users can communicate with their internal team members to collaborate on preparing indicative new issue levels prior to publishing and communicating with their clients. Further, users are able to generate and send indicative pricing sheets in multiple formats such as PDF and Microsoft Word through other delivery channels including email. Users receiving the Pricing Indications can aggregate all Pricing Indications received on the system or view them through traditional communication channels such as a PDF attachment in an email. Additionally, users are able to communicate the current secondary levels, commentaries on the market, and peer group indicative new issue levels through the system. Such information is often used to support the Pricing Indications quoted by market participants. The system allows for advanced visualization of the aggregated data through the Secondary Level Analysis and Visualization 201, Historical Trend Analysis 202, Historical Deal Analysis 203, and Sector & Peer Comparison 204 tools. The aggregated data will be executed by algorithm to form unbiased analysis. Unlike traditional methods that may require longer time to collect data and analyze, the System automates the process and deliver new insights that are currently unavailable. Users are able to aggregate data received on the system and data transmitted through emails and APIs.

Credit and Market Analysis 100 contains several other tools to allow users to analyze the primary market. Namely, the Swap Calculator 205 allows users to convert new issue pricing levels from the platform to equivalent levels in foreign currencies and different interest rate structures. For example, an issuer is able to use the Swap Calculator 205 to find the swapped equivalent rate of its USD and EUR new issues to assess the attractiveness of issuing debt in either USD or EUR. The Secondary Market Liquidity Gauge 206 integrates public data, for example, TRACE, with the user's proprietary private data to gauge current secondary market liquidity, given a particular set of securities and particular group of dealers. The aggregate data is used to teach machine learning algorithms for the purpose of generating new insights that are not currently available. Such a tool is used by primary market participants given the deteriorating secondary market liquidity conditions, driven in part by new regulations. Additionally, the Covenant Analysis Tool 207 allows users to view the covenant set offered by a particular security issuer, compare it over past new issues, and analyze each covenant in detail by accessing the specific covenants language contained in offering documents. The system is designed to recognize the similarities or certain patterns in covenant language. The Documentation Lookup and Analysis 209 tool allows users to access relevant financial documents related to each issuer. The system uses proprietary technology to convert all documents in multiple formats into a standardized format to allow for advanced indexing suited for big data analytics and searching. The system relies on file formats and conversion methods including native application and special conversion action to process file conversions. Further, the system implements search engine techniques to enable users to search relevant key words efficiently. The system also hosts comprehensive Dealer, Issuer, Investor Profiles 210 to allow users to quickly identify each other and perform analysis.

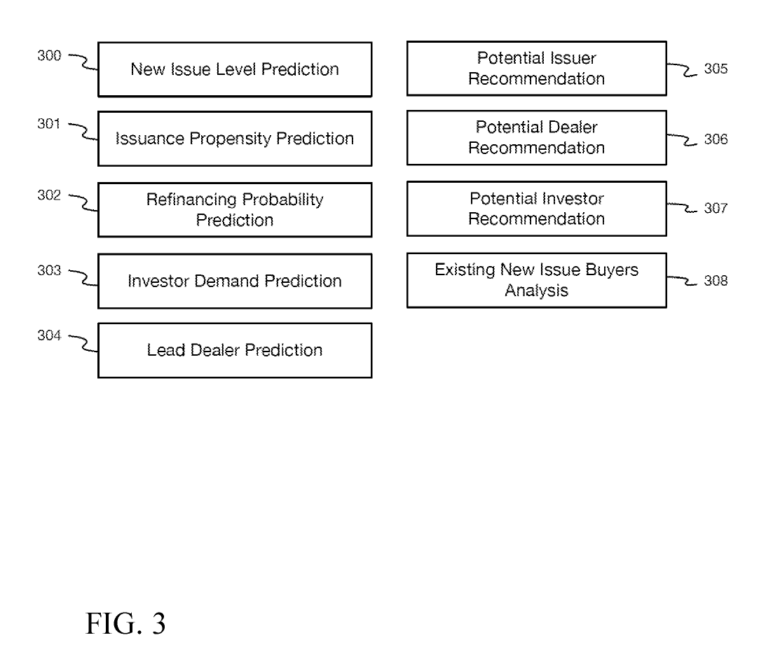

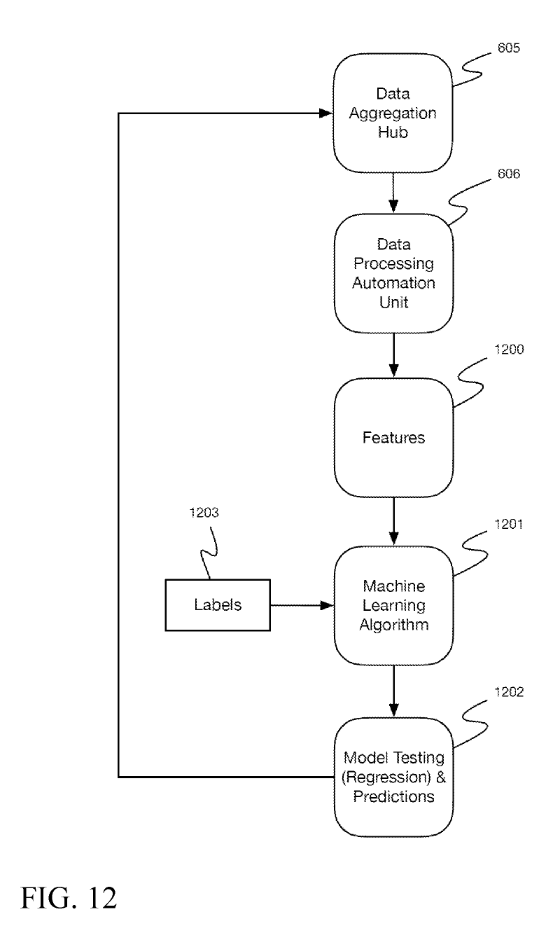

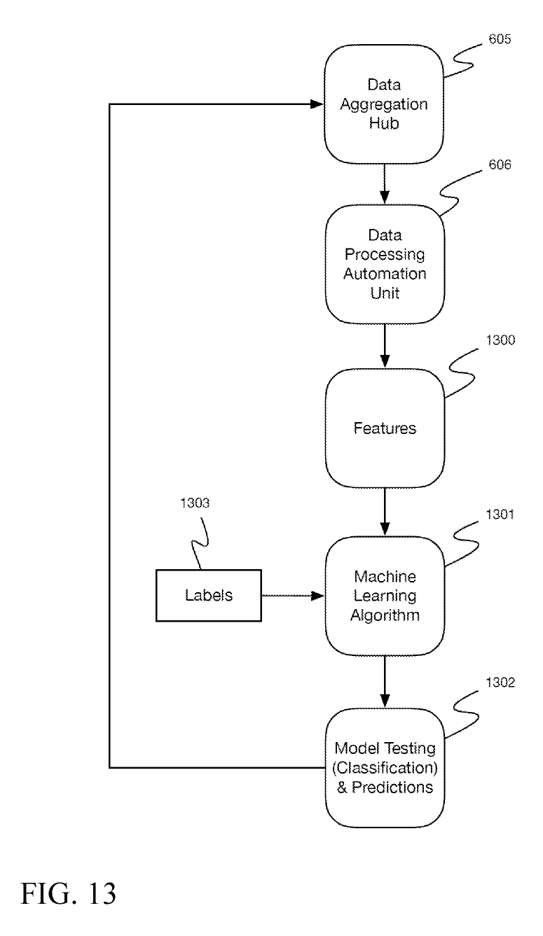

FIG. 3 illustrates a suite of predictive analytics 101 tools that provides users with unique market insights that are currently not available. The system utilizes state-of-the-art technologies to provide market insights that users require to gauge market conditions and to participate in the primary market. New Issue Level Prediction 300 uses machine learning technologies on vast sets of data, such as current and historical secondary market trading levels of correlated securities, to predict new issue levels of specific issuers. This predictive analytics tool complements pricing indications produced primarily by dealers to provide an objective, data-driven view of market levels. The proprietary machine learning process produce New Issue Level Prediction is illustrated on FIG. 12. The system utilizes supervised learning methods and aggregates and cleanses data into a structured data sets to extract features 1200 vectors for the purposes of training machine learning algorithms 1201. Examples of features include current and historical levels and details of new securities issuances, current and historical secondary trading levels of bonds, equities, and derivatives, credit ratings, sector information, financial metrics such as leverage ratios, and market indicators. Multiple types of regression models are employed in supervised training with feature vectors generated through data aggregation and processing units. This process is iterated on a continuous basis using new feature vectors to test predictions and continuous training of the model. The outputs include theoretical clearing new issue levels for securities, implied secondary levels, and implied new issue premiums. Similarly, Issuance Propensity Prediction 301 tool uses a regression-based machine learning algorithm to predict the propensity of a specific issuer to access the new issue market in a given time horizon. This is particularly useful for dealers looking to focus their efforts on providing investment banking coverage to assist with future offerings; investors looking to focus their human resources on analyzing and engaging with issuers that are likely to issue securities in the near future; and any service providers looking to provide solutions or products geared towards primary market activities can use the results as their sales leads. Refinancing Probability Prediction 302 is a variation of the Issuance Propensity Prediction to provide users with the probability of refinancing occurring for each security coming due in a given period of time. Such information is useful to gauge potential new issue supply over a specified time horizon. Investors holding a maturing security can use this information to participate in the refinancing event. Investor Demand Prediction 303 analyzes datasets supplied into the system as well as generated within the system to provide users, particularly dealers and issuers, with a prediction of potential aggregated investor demand for a specific potential new securities issuance. The machine-learning algorithm uses multiple feature vectors such as recent deal participation metrics, deal types, bond holdings data, investor activities, and market indicators to provide predictive insights. Lead Dealer Prediction 304 employs a proprietary algorithm to study historical dealer-issuer relationships such as past deal syndicate structure, lending relationships, and other relevant information to predict the likely dealer to lead the next new issue offered by a specific issuer. Multiple types classification models are trained and tested prior to integrating into the system. FIG. 13 illustrates an overview of classification-based model training. Such information is particularly valuable for users looking to select counterparties to engage with, in the context of primary capital market. Similarly, Potential Issuer Recommendation 305, Potential Dealer Recommendation 306, and Potential Investor Recommendation 307 provides users with the ranking of relevant counterparties to potentially engage with, given a set of criteria such as product specialties, capabilities, demand, and investment track records. For example, a new securities issuer can use the Potential Investor Recommendation 307 tool to generate a list of investors that are likely to invest in the issuer's new offering, based on data-driven predictions. The system provides both explicit rule-based recommendations as well as recommendations based on algorithm trained through supervised training. Furthermore, the Existing New Issue Buyers Analysis 308 tool allows users, specifically issuers and dealers, to upload the buyer list of historical new issues. The system analyzes the buyer list and provides an optimized list of potential investor matches. The optimization is configurable based on pre-determined feature vectors to arrive at the most relevant matches. The result uses a system that also incorporates public information such as investor holdings, investor mandates and sector preferences, and investor historical new issue participation patterns.

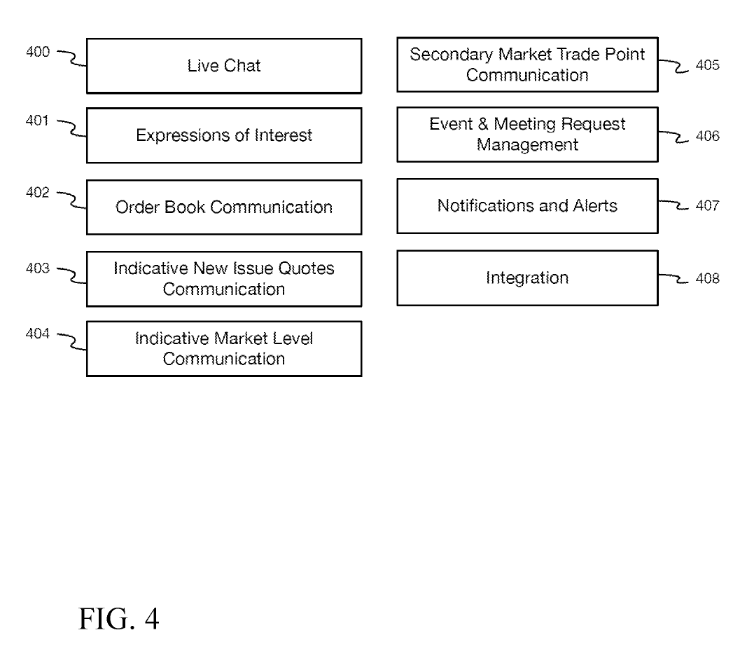

FIG. 4 provides an overview of various communication tools 102 that provide users with multiple, user-friendly, channels of communications. The Live Chat 400 module allows users to communicate instantly with other users on the system. The module provides secure communication over HTTPS and may include end-to-end encrypted messaging services. The system is also offered through a Single Page Application interface, which allows for advanced notification and chatting capabilities. For example, users are able to have multiple chat boxes within the system's web page. This is particularly useful as users are able to communicate seamlessly without leaving a page, staying within the context of each workflow. The Live Chat 400 module also supports group chatting to facilitate multi-user meetings such as syndicate group meetings. The Expression of Interest 401 tool, is an invention that allows users to communicate pre-deal interests (“Reverse Inquiries”) with each other. Specifically, investor users are able to select target issuers, fill in inquiry details such as tenor, interest size, structure, currency, pricing levels, expiry date, and others. Users with pre-approved permissions are also able to create Reverse Inquiries on behalf of other users. For example, an issuer user may receive a Reverse Inquiry through the form of electronic email. They may forward the electronic mail to a secure mailbox maintained by the system—the Reverse Inquiry will be logged on the platform for recordkeeping purposes. Similarly, dealer users may act on behalf of their clients on both investor and issuer side to reflect latest developments. Users are also able to see a clear audit trail of creation of digital Reverse Inquiries and any modifications. Users are also able to communicate through a secure channel with the appropriate counterparties. Investor users have the option to submit Reverse Inquiries anonymously and may share the inquiry details with dealers intermediating the potential new issue. All the system's specific features are customizable subject to a user's permissions. These permissions are determined from the various regulations applicable to a given user, and thus prevent users from performing certain activities. Order Book Communication 402 allows users to securely communicate the state of a live or closed order book with other relevant counterparties. This is an essential part of the book building process. Indicative New Issue Quotes Communication 403 and Indicative Market Level Communication 404 modules enable various types of all-to-all market intelligence communication as stated for Digital New Issue Level Indications 200. The system allows for privilege controls for internal team members. For example, the system can be configured so that a Debt Capital Markets Analyst (dealer user) may only publish Pricing Indications for a specific list of issuer clients. Secondary Market Trade Point Communication 405 allows users to upload, manage and communicate their trading activities with their counterparties. Further, the Event & Meeting Request Management 406 tool, another embodiment of the invention may include a digital tool to request and schedule meetings with counterparties in the primary capital market. Notifications and Alerts 407 is a built-in system that allows users to seamlessly be alerted through a variety of channels including, but not limited to, in-application notification and alerts, email notifications, Short Message Service (SMS) messages, and automated phone message. The notification management system allows for both internal and external events tracking, customizable cadence, and automatic subscription based on user roles through integration with permission access control. Lastly, the System enables multiple Integration 408 capabilities for all modules. Examples of integration includes the following: Outlook integration, chat channel integration with client-side servers, and data integration with client-side servers via APIs.

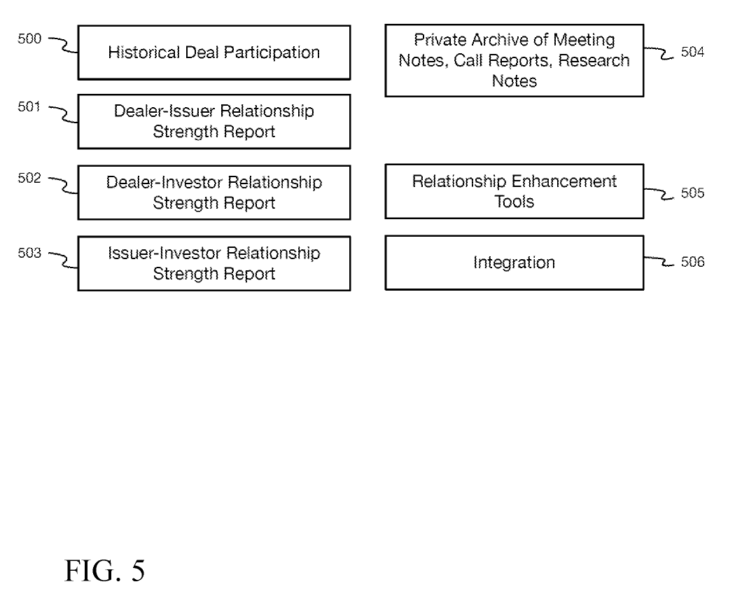

Referring to FIG. 5, an embodiment of the invention includes a suite of relationship management 103 tools. A user of the system is able manage aspects of relationships with counterparties on the system. Through the Historical Deal Participation 500 tool, users track historical records of deal participation using a private database management system. Through Dealer-Issuer Relationship Strength Report 501, Dealer-Investor Relationship Strength Report 502, and Issuer-Investor Relationship Strength Report 503 modules, a system user can gauge the state of the relationship maturity with a given primary market counterparty. For example, an issuer user may generate a multi asset class capital markets relationships report to analyze the overall relationship summary and scoring with each of its dealer counterparts. Similarly, an investor user may generate a multi asset class capital markets relationship report to analyze the overall relationship summary and scoring with each of its dealer counterparts. Private Archive of Meetings, Call Reports, and Research Notes 504 may be maintained by users to streamline recordkeeping and financial analysis. Lastly, the system enables multiple integration 506 capabilities for all modules. Such integration includes the following: Outlook integration, chat channel integration with client-side servers, data integration with client-side servers via APIs.

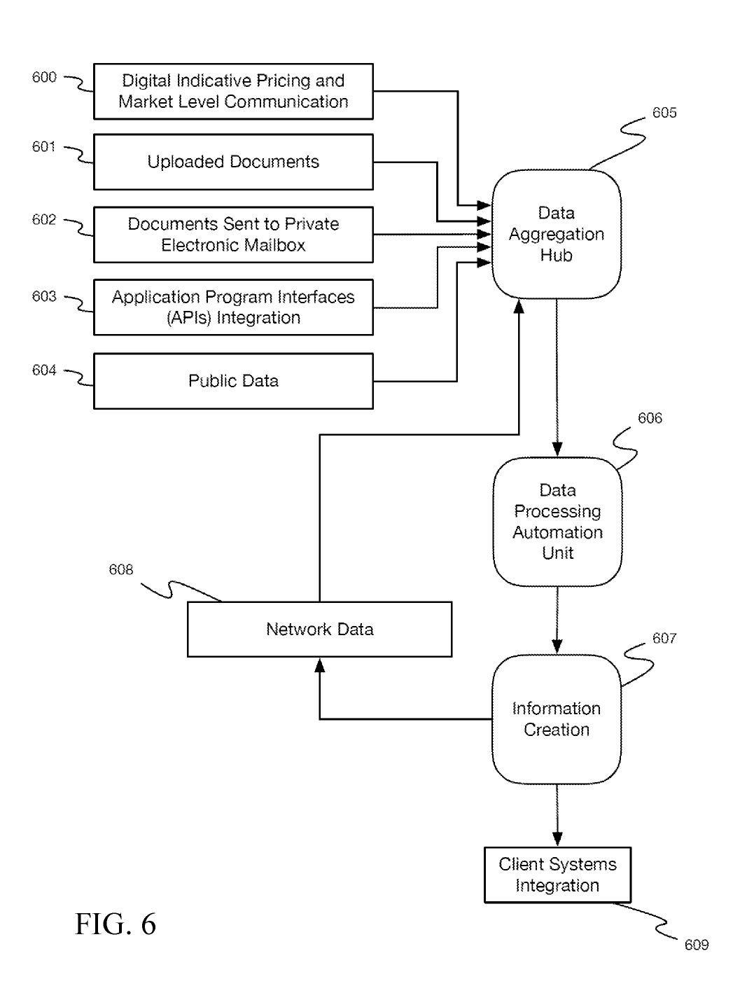

FIG. 6 is an overview of systems to aggregate, process, and integrate data from multiple sources into and out of a centralized data aggregation, management, and processing 104, in the context of primary capital markets. The system relies on abstract APIs and a data feed consuming pipeline capable of interoperating with multiple capital market feeds real-time. Furthermore, market data is stored and cached, with millions of data points in a unified document architecture. The system contains a corresponding database/document architecture and caching layer for the persistence of serving market data to internal application components. Further, the system may employ Redis clusters with multiple replicas to minimize web latency. Internal application abstraction from market data feeds is achieved through an internal micro-services architecture. Verification of federated data scalability is achieved through load-testing for both concurrent users and data volumes. Data Aggregation Hub 605, which interfaces with multiple data providers including Digital Indicative Pricing and Market Level Communication 600, Uploaded Document 601, Documents Sent to Private Electronic Mailbox 602, Application Program Interfaces 603, and Public Data 604. As well, Network Data 608, metadata generated by the usage of the system is transmitted back into the Data Aggregation Hub 605 to further enrich data quality and supply information needed for various predictive analytics modules. Data Processing Automation Unit 606 formats, filters, and reconciles records prior to being transmitted for use by system users. In addition, advanced natural language processing techniques may be utilized to synthesize, extract keywords (for example, unique identifiers, company name), perform sentiment analysis, and extract transaction related terms such as covenants and legal term definitions. The system allows for Client Systems Integration 609, providing the ability to synchronize datasets with users' internal systems through secure application program interfaces.

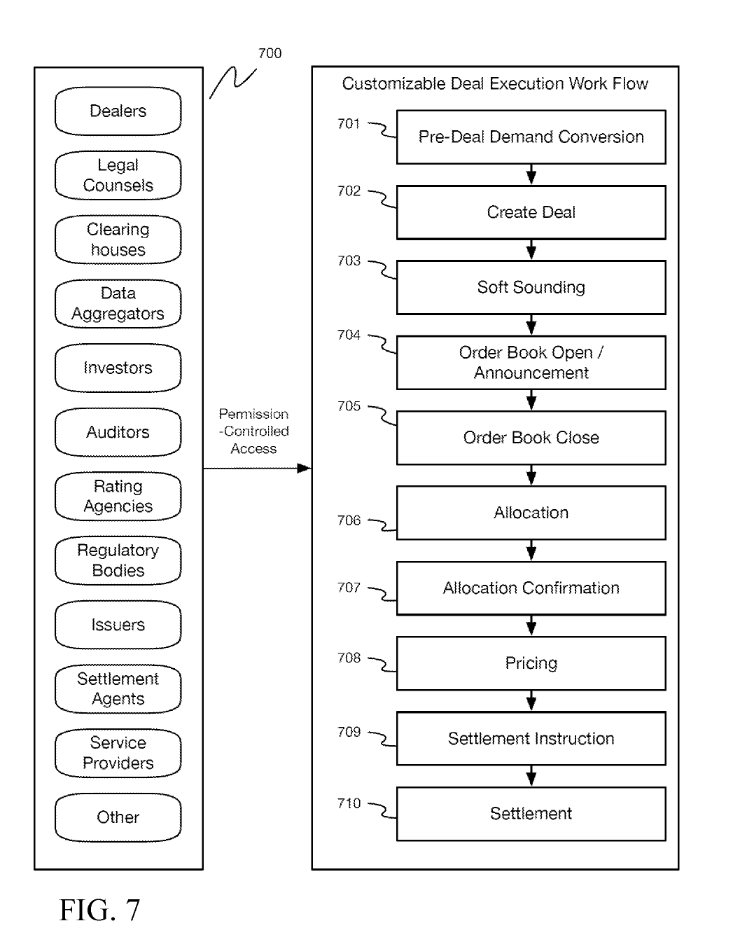

FIG. 7 is an overview of a customizable digital deal execution workflow 110 with permission-controlled access provided to multiple stakeholders. In embodiments of the invention, Pre-Deal Demand conversion 701 is a step-by-step process that allows the issuer and/or dealer to Create Deals 702 and populate it with existing Reverse Inquiries and continue the process of gauging interest by Soft Sounding 703, Opening an Order Book 704, Closing Order Book 705, Allocating 706, Allocation Confirmation 707 with Investors, Pricing 708 and settling the transaction 709 710. The deal execution module provides highly customizable deal execution workflow and permission sets for different users.

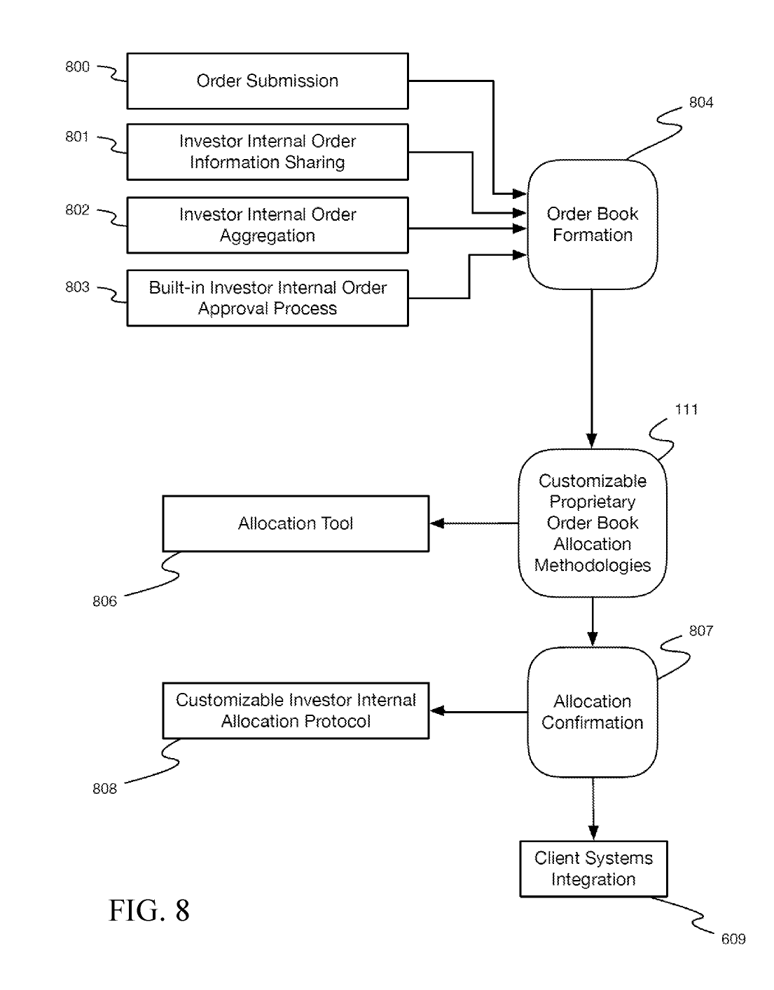

Referring to FIG. 8, embodiments of the invention may include a module that applies Customizable Proprietary Order Book Allocation Methodologies 111 to manage and allocate order books. An order book may be populated by investor and dealer users through the Order Submission 800 interface. Investors may share order information internally to aggregate orders from multiple portfolio managers and to facilitate a streamlined order approval process 801 802 803. Algorithm used for the Allocation Tool 806 may use information such as order size, relationship strength report, predictive metrics, and order submission time to provide suggested allocation amounts for each order. The Allocation Confirmation 807 tool may include real-time, two-way communication between the syndicate and investors to maintain the latest status of the order book. The tool may be extended to include an investor-side internal allocation protocol 808 to further allocate the new issue within an investor organization.

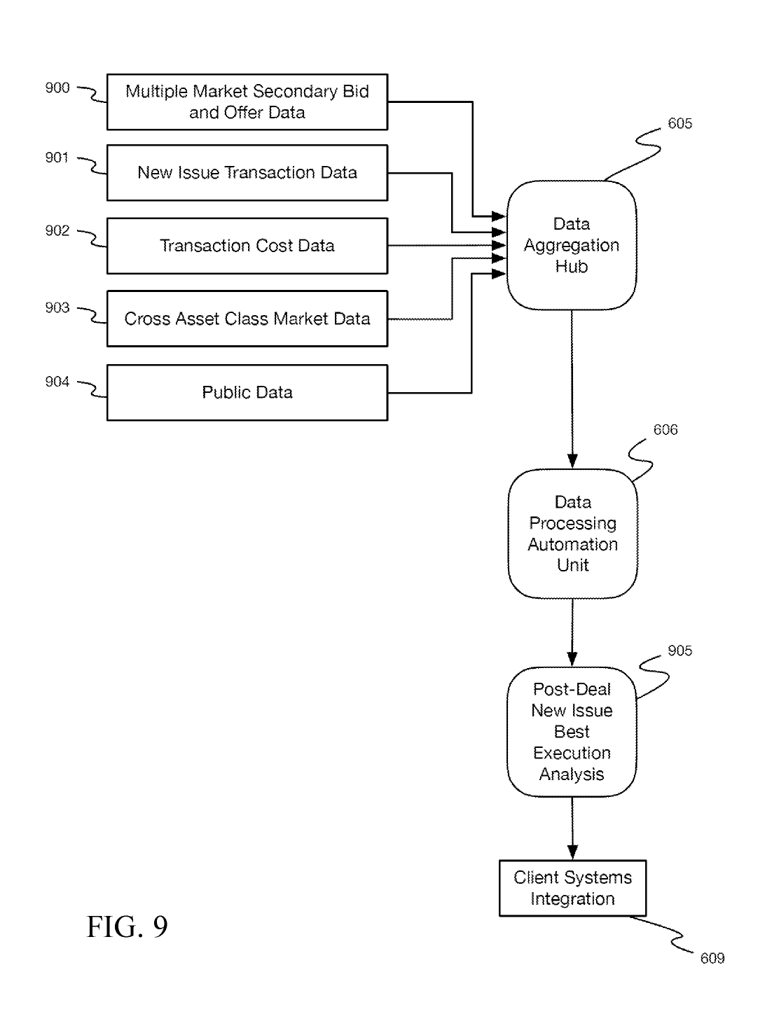

FIG. 9 is an overview of customizable digital deal execution 112 workflow with permission-controlled access provided to multiple stakeholders. The system's Post-Deal Best Execution Analytics 905 provides reporting solutions that generate reports and metrics on specific new issue execution by taking into account multiple data points including Multiple Market Secondary Bid and Offer Data 900, New Issue Transaction Data 901, Transaction Cost Data 902, Cross Asset Class Market Data 903, and other Public Data 904. The Best Execution algorithm includes weighting on various pricing trends to identify useful statistics such as theoretical clearing pricing levels, optimal dealer selection, and optimal market timing. Further, the module provides regulatory compliance reports for a given new issue trade.

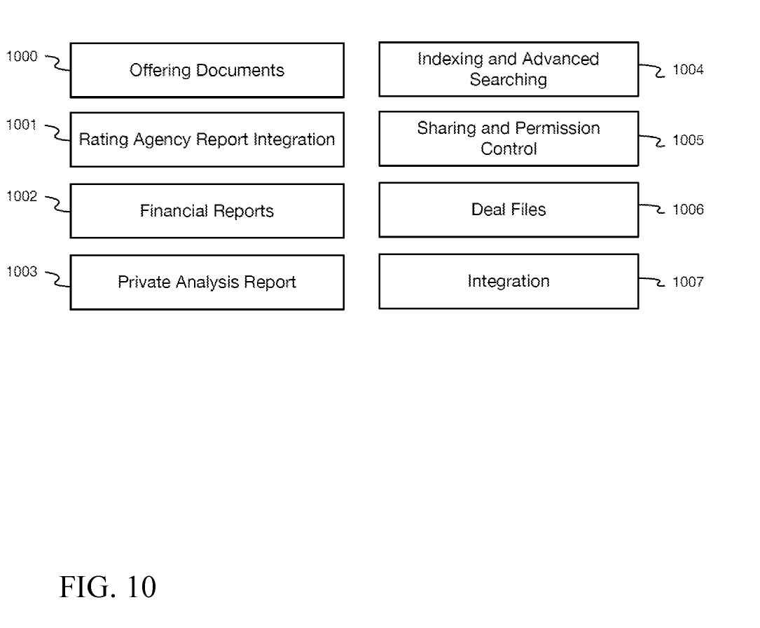

FIG. 10 is an integrated suite of tools that allow users to manage multiple financial documents 113 including Offering Documents 1000, Rating Agency Reports 1001, Financial Reports 1002, Private Analysis Reports 1003, and Deal Files 1006. The module may include complete indexing and searching capabilities 1004 to provide seamless access to relevant documents. The module leverages proprietary technology for financial documents that may be built on top of Apache Lucene to provide real-time indexing and faceted search of all document contents. As well, access to documents are controlled through customizable Sharing and Permission Control 1005 protocol built into the system. Lastly, the system enables multiple Integration 1007 capabilities for all modules. Such integration includes the following: integration with client-side servers, data integration with client-side servers via APIs, file backup protocols through client side server integration.

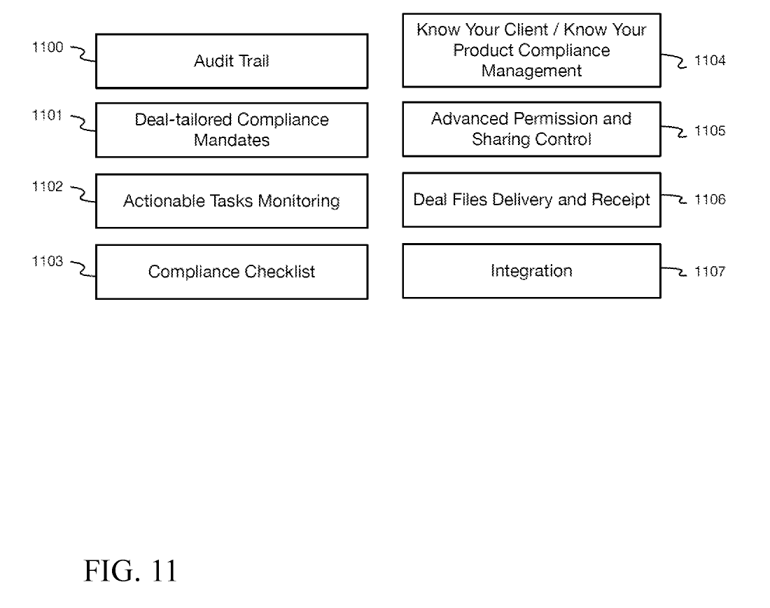

FIG. 11 is a suite of tools available for users to comply with the relevant regulatory compliance 114 requirements. The module is customizable to allow users to meet with relevant regulatory compliance and reporting mandates. These include complete Audit Trail 1100 of all user activities, built-in Deal-tailored Compliance Mandates 1101, Actionable Tasks Monitoring 1102, customizable Compliance Checklist 1103, and Know Your Client (KYC)/Know Your Product Compliance Management 1104. The tool allows users to generate regulatory reports related to non-deal and deal-related activities of all user types. The invention may also contain direct Integration 1107 service with client-side servers.

FIG. 12 depicts an overview of continuous supervised machine learning process according to an embodiment of the invention using regression models for the purpose of Digital New Issue Indication predictive analytics tool. Accordingly, as with the preceding descriptions in respect of FIGS. 1 to 11 the system relies on abstract APIs and a data feed consuming pipeline capable of interoperating with multiple capital market feeds real-time. Market data is stored and cached, with millions of data points in a unified document architecture and the system contains a corresponding database/document architecture and caching layer for the persistence of serving market data to internal application components. Internal application abstraction from market data feeds is achieved through an internal micro-services architecture. Accordingly, the process flow depicted exploits the Data Aggregation Hub 605 as described supra in respect of FIG. 6 which provides the Data Processing Automation Unit 606 with the data and supply information necessary for it to perform the required predictive analytics. Accordingly, Features 1200 defines the features of the regression sought and these together with the Labels 1203 are coupled to the Machine Learning Algorithm 1201 to generate the analytic algorithm between the features identified. Based upon the execution of the Machine Learning Algorithm 1201 the model is tested, for example through regression analysis, and exploited to make predictions with Model Testing (Regression) & Predictions Module 1202. At this point the output from the model testing and predictions are fed-back to the Data Aggregation Hub 605 allowing the process to iterate and exploit new data during these subsequent iterations.

Now referring to FIG. 13 there is depicted an overview of continuous supervised machine learning process according to an embodiment of the invention using regression models for the purpose of Digital New Issue Indication predictive analytics tool. Accordingly, as with the preceding descriptions in respect of FIGS. 1 to 12 the system relies on abstract APIs and a data feed consuming pipeline capable of interoperating with multiple capital market feeds real-time. Market data is stored and cached, with millions of data points in a unified document architecture and the system contains a corresponding database/document architecture and caching layer for the persistence of serving market data to internal application components. Internal application abstraction from market data feeds is achieved through an internal micro-services architecture. Accordingly, the process flow depicted exploits the Data Aggregation Hub 605 as described supra in respect of FIG. 6 which provides the Data Processing Automation Unit 606 with the data and supply information necessary for it to perform the required predictive analytics. Accordingly, Features 1300 defines the features of the regression sought and these together with the Labels 1303 are coupled to the Machine Learning Algorithm 1301 to generate the analytic algorithm between the features identified. Based upon the execution of the Machine Learning Algorithm 1301 the model is tested, for example through regression analysis, and exploited to make predictions with Model Testing (Regression) & Predictions Module 1302. At this point the output from the model testing and predictions are fed-back to the Data Aggregation Hub 605 allowing the process to iterate and exploit new data during these subsequent iterations.

Examples of models employed within the Machine Learning Algorithm 1201/1301 and as exploited for model testing, regression and predictions may include, but are not limited to, linear regression, polynomial regression, general linear model, generalized linear model, discrete choice, logistic regression, multinomial logit, mixed logit, probit, multinomial probit, Poisson, multilevel model, fixed and/or random effects, non-linear regression, non-parametric, semi-parametric, robust, quantile, isotonic, principal components, local segments, and errors-in-variables. Examples of estimation models employed within the Model Testing (Regression) & Predictions Module 1202/1302 and as exploited for model testing, regression and predictions include, but are not limited to, least squares, partial, total, generalized, weighted, non-linear, iteratively reweighted, ridge regression, least absolute deviations, Bayesian, and Bayesian multivariate.

Referring to FIG. 14 there is illustrated a table of financial data and rates as employed commonly within financial transactions and decision making. As depicted the table presents several standard factors, namely Maturity, Benchmark, Benchmark Yied, Re-Offer Spread, Re-Offer Yield, and Swapped Spread relative to US$ London Interbank Offered Rate (LIBOR). Against each of these are depicted different financial “products” which in this instance are different term US Treasury bonds for each of the selected maturity terms, namely 5 year, 10 year, and 30 year.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. An interactive digital platform for trading in primary market offerings of securities, the platform comprising:
a pre-deal activity module configured to allow a plurality of users to perform credit and market analysis, predictive analytics, communications functions, relationship management, and information management; and
a deal execution module configured to allow the plurality of users to perform a deal execution workflow, order management, best execution analysis, documentation management, and regulatory compliance.

2. The platform of claim 1 wherein the credit and market analysis comprises publish pricing levels to other users of the plurality of users using a common format, swap analysis, evaluation of secondary market liquidity, machine comparison of covenant terms, and evaluation of profiles of the plurality of users.

3. The platform of claim 1 wherein the predictive analytics comprises machine learning and big data, evaluating participation in primary markets, the evaluation of current and historic secondary market trading levels of correlated securities, and the prediction of new issue levels.

4. The platform of claim 1 wherein the communications functions comprise publishing pricing indications publicly or privately to other users of the plurality of users.

5. The platform of claim 1 wherein the relationship management comprises the tracking of historical records of deal participation by the plurality of users.

6. The platform of claim 1 wherein the information management comprises receiving a plurality of digitized primary market data from a plurality of sources, the platform digitizing the plurality of digitized primary market data, converting the plurality of digitized primary market data into a common format, and storing the plurality of primary market data into a database;

7. The platform of claim 1 wherein the deal execution workflow comprises enabling the plurality of users to create a plurality of deals and populate the plurality of deals with a plurality of existing reverse inquiries, soft sounding being used to gauge interest in the plurality of deals.

8. The platform of claim 1 wherein the order management comprises enabling the plurality of users to populate and allocate orders and submit orders for trading.

9. The platform of claim 1 wherein the best execution analysis comprises the utilization, by the platform, of bid and offer data to produce a weighting of pricing trends.

10. The platform of claim 6 wherein the documentation management comprises the indexing of the plurality of digitized primary market data to enable the plurality of users to search the plurality of digitized primary market data.
